(19) United States
(12) Patent Application Publication
(10) Pub. No.: US 2012/0150936 A1
(43) Pub. Date: Jun. 14, 2012

(54) DISTRIBUTION SYSTEM

(75) Inventor: Hiroshi Yoshida, Tokyo (JP)

(73) Assignee: Nec Corporation, Minato-ku (JP)

(21) Appl. No.: 13/389,767

(22) PCT Filed: Jun. 2, 2010
(86) PCT No.: PCT/JP2010/003673

§ 371 Date: Feb. 9, 2012

(30) Foreign Application Priority Data
Aug. 10, 2009 (JP) 2009-186118

(51) Int. Cl. G06F 15/16

(52) U.S. Cl. 709/201

(57) ABSTRACT

A distribution system 1C includes a server device 801 and a client device 802. The server device 801 transmits, to the client device 802, media data which is formed by encoding content at a media rate among a plurality of different media rates. While receiving the media data, the client device 802 stores the received data in a storage device and reproduces the content based on the stored data. Based on an objective function which is a function in which a transmission rate, representing a data quantity of the media data transmitted by the server device 801 per unit time, and the media rate respectively serve as variables, the distribution system 1C outputs a combination of the transmission rate and the media rate. The server device 801 transmits, at the selected transmission rate, the media data encoded at the selected media rate.

### TECHNICAL FIELD

The present invention relates to a distribution system including a server device which distributes media data representing content and a client device which receives media data from the server device.

### BACKGROUND ART

A distribution system including a server device which distributes media data representing content and a client device which receives media data from the server device has been known. A server device is adapted to be able to transmit media data, formed by encoding content at an arbitrary media rate among a plurality of different media rates, to a client device.

Further, a client device is adapted to, while receiving media data transmitted from a server device, store received data of the media data in a storage device and also reproduce content based on the stored data.

As one distribution system of such a type, a distribution system described in Patent Document 1 controls a transmission rate based on the remaining reproduction time which is a time period in which the content can be reproduced, based on the portion which has not been reproduced of the data stored in a storage device of a client device. A transmission rate represents a data quantity of media data to be transmitted by a server device per unit time.

Further, this distribution system controls a media rate based on a pack loss rate (proportion of occurrence of packet loss). A media rate represents a data quantity of media data for reproducing content for a unit time.

Thereby, it is possible to make the remaining reproduction time close to a preset target value while preventing occurrence of packet loss.
Patent Document 1: JP 2003-174489 A

Media rates of media data transmittable by a server device are likely to differ from each other relatively widely (for example, 1 Mbps, 4 Mbps, 8 Mbps, and the like). As such, even if an available bandwidth (that is, packet loss rate) which is a usable communication bandwidth for transmitting media data from a server device to a client device varies relatively small, the distribution system described above may vary the media rate relatively widely.

When a media rate varies relatively widely, QoE (Quality of Experience) drops relatively widely. It should be noted that QoE is a service quality experienced by a user of a client device when the user views content reproduced by the client device. In such a case, by changing the transmission rate, there is a possibility of making the remaining reproduction time close to a target value while maintaining the media rate at almost constant, for example.

However, because the distribution system controls the transmission rate based on the remaining reproduction time, in the case where the available bandwidth varies, the transmission rate cannot be controlled at a point of time before the remaining reproduction time varies. Consequently, the above-described distribution system is not able to output an appropriate combination of a transmission rate and a media rate. As such, in the distribution system described above, QoE may be lowered excessively due to a relatively large variation in the media rate.

Further, when the remaining reproduction time becomes smaller than a target value, the above-described distribution system increases the transmission rate. As a result, packet loss is likely to be caused. Then, when detecting an increase in the packet loss rate, the above-described distribution system decreases the media rate. It should be noted that in addition to an increase in the transmission rate, the remaining reproduction time is also increased due to a decrease in the media rate. Consequently, when the remaining reproduction time becomes larger than a target value, the above-described distribution system decreases the transmission rate.

As described above, in the distribution system described above, as the transmission rate and the media rate affect each other, a relatively long delay time is required until a combination of a transmission rate and a media rate reach appropriate values (final controlled values). As such, a state where QoE is relatively low could be maintained for an excessively long period.

### SUMMARY

In view of the above, an object of the present invention is to provide a distribution system capable of solving the above-described problem, that is, “a drop in Quality of Experience”.

In order to achieve the object, a distribution system, which is an aspect of the present invention, is a system including a server device and a client device adapted to be communicable with each other.

The server device is adapted to be able to transmit, to the client device, media data which is formed by encoding content at an arbitrary media rate among a plurality of different media rates.

The client device is adapted to, while receiving the media data transmitted by the server device, store received data of the media data in a storage device and reproduce the content based on the stored data.

The distribution system further includes:

a rate output means for outputting a combination of a transmission rate and a media rate based on an objective function, the objective function being a function in which a transmission rate representing a data quantity of the media data transmitted by the server device per unit time and the media rate respectively serve as variables, and also a function in which a Quality of Experience value is determined so as to correspond to the variables, the Quality of Experience value being a value representing Quality of Experience which is a service quality experienced by a user of the client device when the user views the content reproduced by the client device, and

a media data transmission means for transmitting, by the server device, the media data encoded at the output media rate, to the client device at the output transmission rate.

Further, a distribution method, which is another aspect of the present invention, is a method applied to a distribution system including a server device and a client device adapted to be communicable with each other.

The server device is adapted to be able to transmit, to the client device, media data which is formed by encoding content at an arbitrary media rate among a plurality of different media rates.

The client device is adapted to, while receiving the media data transmitted by the server device, store received data of the media data in a storage device and reproduce the content based on the stored data.

The distribution method includes:

outputting a combination of a transmission rate and a media rate based on an objective function, the objective function being a function in which a transmission rate representing a data quantity of the media data transmitted by the server device per unit time and the media rate respectively serve as variables, and also a function in which a Quality of Experience value is determined so as to correspond to the variables, the Quality of Experience value being a value representing Quality of Experience which is a service quality experienced by a user of the client device when the user views the content reproduced by the client device, and

transmitting, by the server device, the media data encoded at the output media rate, to the client device at the output transmission rate.

Further, a server device, which is another aspect of the present invention, is a device adapted to be communicable with a client device.

The server device is adapted to be able to transmit, to the client device, media data which is formed by encoding content at an arbitrary media rate among a plurality of different media rates, and includes:

a rate output means for outputting a combination of a transmission rate and a media rate based on an objective function, the objective function being a function in which a transmission rate representing a data quantity of the media data transmitted by the server device per unit time and the media rate respectively serve as variables, and also a function in which a Quality of Experience value is determined so as to correspond to the variables, the Quality of Experience value being a value representing Quality of Experience which is a service quality experienced by a user of the client device when the user views the content reproduced by the client device, and

a media data transmission means for transmitting the media data encoded at the output media rate, to the client device at the output transmission rate.

Further, a program, which is another aspect of the present invention, is a program for causing a server device to realize, the server device being adapted to be communicable with a client device and also adapted to be able to transmit, to the client device, media data which is formed by encoding content at an arbitrary media rate among a plurality of different media rates:

a rate output means for outputting a combination of a transmission rate and a media rate based on an objective function, the objective function being a function in which a transmission rate representing a data quantity of the media data transmitted by the server device per unit time and the media rate respectively serve as variables, and also a function in which a Quality of Experience value is determined so as to correspond to the variables, the Quality of Experience value being a value representing Quality of Experience which is a service quality experienced by a user of the client device when the user views the content reproduced by the client device, and

a media data transmission means for transmitting the media data encoded at the output media rate, to the client device at the output transmission rate.

Further, a client device, according to another aspect of the present invention, is a device adapted to be communicable with a server device which is adapted to be able to transmit, to the client device, media data which is formed by encoding content at an arbitrary media rate among a plurality of different media rates.
The client device is adapted to, while receiving the media data transmitted by the server device, store received data of the media data in a storage device and reproduce the content based on the stored data, and includes:

a rate output means for outputting a combination of a transmission rate and a media rate based on an objective function, the objective function being a function in which a transmission rate representing a data quantity of the media data transmitted by the server device per unit time and the media rate respectively serve as variables, and also a function in which a Quality of Experience value is determined so as to correspond to the variables, the Quality of Experience value being a value representing Quality of Experience which is a service quality experienced by a user of the client device when the user views the content reproduced by the client device, and

a request transmission means for transmitting, to the server device, a transmission request which is a request to transmit the media data encoded at the output media rate, at the output transmission rate.

Further, a program, which is another aspect of the present invention, is a program for causing a client device to realize, the client device being adapted to be communicable with a server device which is adapted to be able to transmit, to the client device, media data which is formed by encoding content at an arbitrary media rate among a plurality of different media rates, and is also adapted to, while receiving the media data transmitted by the server device, store received data of the media data in a storage device and reproduce the content based on the stored data:

a rate output means for outputting a combination of a transmission rate and a media rate based on an objective function, the objective function being a function in which a transmission rate representing a data quantity of the media data transmitted by the server device per unit time and the media rate respectively serve as variables, and also a function in which a Quality of Experience value is determined so as to correspond to the variables, the Quality of Experience value being a value representing Quality of Experience which is a service quality experienced by a user of the client device when the user views the content reproduced by the client device, and

a request transmission means for transmitting, to the server device, a transmission request which is a request to transmit the media data encoded at the output media rate, at the output transmission rate.

Further, a distribution control method, which is another aspect of the present invention, is a method for controlling transmission of media data formed by encoding content, from a server device to a client device.

The distribution control method includes

outputting a combination of a transmission rate and a media rate based on an objective function, the objective function being a function in which a transmission rate representing a data quantity of the media data transmitted by the server device per unit time and a media rate representing a data quantity of the media data for reproducing the content per unit time serve as variables, and also a function in which a Quality of Experience value is determined so as to correspond to the variables, the Quality of Experience value being a value representing Quality of Experience which is a service quality experienced by a user of the client device when the user views the content reproduced by the client device.

Further, a relay device, which is another aspect of the present invention, is a device adapted to be communicable with a server device and with a client device.

The relay device is also adapted to transfer media data, formed by encoding content, from the server device to the client device, and includes:

a transmission rate acquisition means for acquiring, as a transmission rate, a transfer rate which is a data quantity of the media data transferred per unit time from the server device to the client device, and

a transmission rate transmission means for transmitting the acquired transmission rate to the server device.

Further, a relay method, which is another aspect of the present invention, is a method applied to a relay device adapted to be communicable with a server device and with a client device.

The relay method includes:

transferring media data, formed by encoding content, from the server device to the client device;

acquiring, as a transmission rate, a transfer rate which is a data quantity of the media data transferred per unit time from the server device to the client device; and

transmitting the acquired transmission rate to the server device.

Further, a program, which is another aspect of the present invention, is a program for causing a relay device to realize, the relay device being adapted to be communicable with a server device and with a client device and also adapted to transfer media data, formed by encoding content, from the server device to the client device:

a transmission rate acquisition means for acquiring, as a transmission rate, a transfer rate which is a data quantity of the media data transferred per unit time from the server device to the client device, and

a transmission rate transmission means for transmitting the acquired transmission rate to the server device.

With the configurations described above, the present invention is able to improve Quality of Experience.

### BRIEF DESCRIPTION OF DRAWINGS

FIG. 1 is a diagram showing the schematic configuration of a distribution system according to a first exemplary embodiment of the present invention.

FIG. 2 is a block diagram schematically showing functions of the distribution system according to the first exemplary embodiment of the present invention.

FIG. 3 is a flowchart showing a rate control program to be executed by a CPU of a server device according to the first exemplary embodiment of the present invention.

FIG. 4 is a block diagram schematically showing functions of a distribution system according to a second exemplary embodiment of the present invention.

FIG. 5 is a diagram showing the schematic configuration of a distribution system according to a third exemplary embodiment of the present invention.

FIG. 6 is a block diagram schematically showing functions of the distribution system according to the third exemplary embodiment of the present invention.

FIG. 7 is a block diagram schematically showing functions of a distribution system according to a fourth exemplary embodiment of the present invention.

### EXEMPLARY EMBODIMENTS

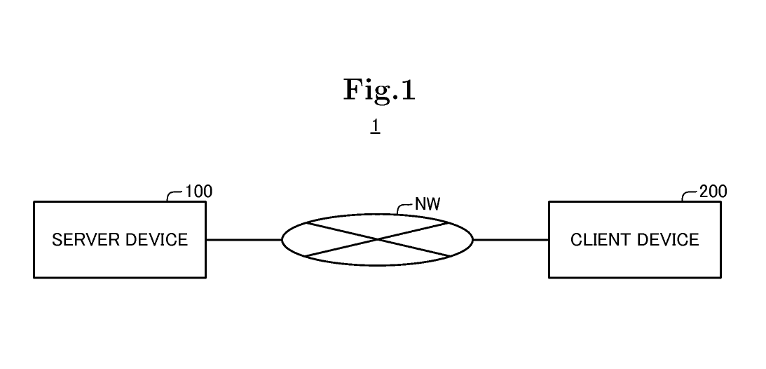

Hereinafter, respective embodiments of a distribution system, a distribution method, a server device, a program, a client device, a distribution control method, a relay device, and a relay method will be described with reference to FIGS. 1 to 7.

### First Exemplary Embodiment

As shown in FIG. 1, a distribution system 1 according to a first exemplary embodiment includes a server device 100 and a client device 200. The server device 100 and the client device 200 are communicably connected with each other over a communication network NW (e.g., the Internet).

The server device 100 includes a central processing unit (CPU) and storage devices (memory and hard disk drive (HDD)), not shown. The server device 100 is adapted to realize functions described below by means of execution of programs stored in the storage devices by the CPU.

The client device 200 is a personal computer. It should be noted that the client device 200 may be a mobile telephone, a PHS (Personal Handy-phone System), a PDA (Personal Data Assistance, Personal Digital Assistant), a TV receiver, a set top box, a game console, a car navigation device, or the like.

The client device 200 includes a central processing unit (CPU), a storage device (memory), input devices (e.g., keyboard, mouse, and the like), and output devices (e.g., display, speaker, and the like), not shown. The client device 200 is adapted to realize functions described below by means of execution of programs stored in the storage device by the CPU.

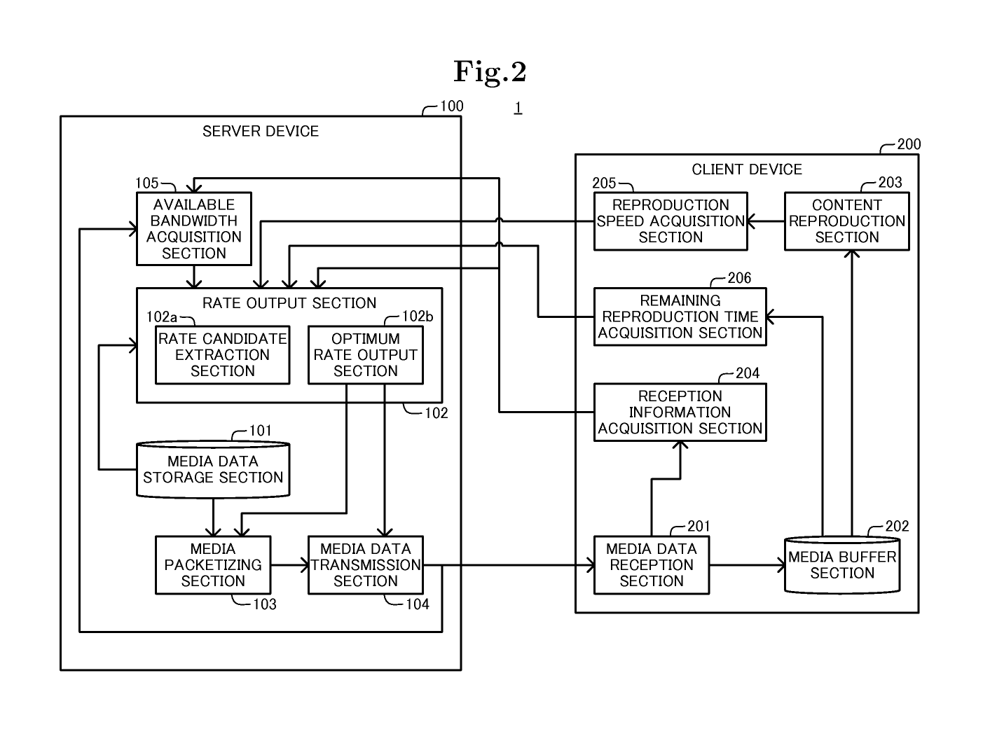

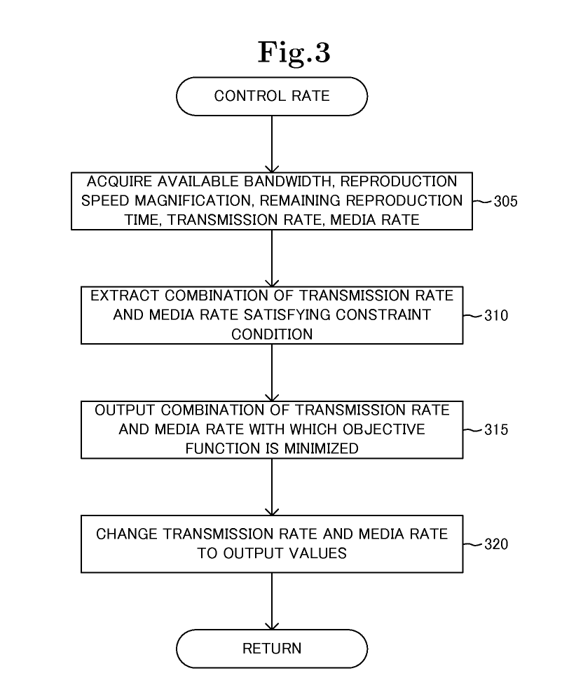

FIG. 2 is a block diagram showing the functions of the distribution system 1 configured as described above. These functions are realized by means of execution of a program described in the flowchart shown in FIG. 3 described below, and the like, by the CPU of the server device 100, and by means of execution of a predetermined program by the CPU of the client device 200.

The functions of the server device 100 includes a media data storage section (media data storage means) 101, a rate output section (rate output means) 102, a media packetizing section 103, a media data transmission section (media data transmission means) 104, and an available bandwidth acquisition section (available bandwidth acquisition means) 105.

Further, the functions of the client device 200 includes a media data reception section 201, a media buffer section 202, a content reproduction section 203, a reception information acquisition section (transmission rate acquisition means, transmission rate transmission means) 204, a reproduction speed acquisition section (reproduction speed acquisition means) 205, and a remaining reproduction time acquisition section (remaining reproduction time acquisition means) 206.

The media data storage section 101 of the server device 100 stores (accumulates) a plurality of items of media data in advance. Media data is data formed by encoding content (e.g., information representing video and/or sound) at a plurality of different media rates respectively. A media rate represents a data quantity (data size, that is, the number of bytes, for example) of media data for reproducing at a constant velocity (reproducing at a single speed) the content in a unit time (e.g., one second).

The rate output section 102 of the server device 100 selects a combination of a transmission rate and a media rate, and outputs the selected combination of the transmission rate and the media rate. A transmission rate represents a data quantity (e.g., the number of bytes) of media data to be transmitted by the server device 100 in a unit time (e.g., one second). The details of the rate output section 102 will be described below.

The media packetizing section 103 of the server device 100 acquires, among media data stored in the media data storage section 101, a piece of media data encoded at a media rate r* output by the rate output section 102. Then, the media packetizing section 103 generates packets based on the acquired media data (that is, packetizes the acquired media data).

In this example, the media packetizing section 103 generates packets in accordance with RTP (Real-Time Transport Protocol). It should be noted that the media packetizing section 103 may be adapted to generate packets by means of another method (in accordance with another communication protocol).

The media data transmission section 104 of the server device 100 transmits the packets (that is, media data) generated by the media packetizing section 103 to the client device 200 such that the data quantity transmitted in a unit time conforms to the transmission rate v* output by the rate output section 102.

In this example, the server device 100 receives a content transmission request from the client device 200, and transmits media data identified by the received content transmission request, to the client device 200.

The data reception section 201 of the client device 200 receives packets (that is, media data) transmitted by the media data transmission section 104 of the server device 100.

The media buffer section 202 of the client device 200 stores, during the time that media data is received by the media data reception section 201, received data of the media data.

The content reproduction section 203 of the client device 200 reproduces content based on the data stored in the media buffer section 202 (outputs via an output device). Further, the content reproduction section 203 includes a function of changing a reproduction speed which is a speed of reproducing content, in response to an instruction by a user.

As such, the client device 200 is adapted to store, while receiving media data transmitted by the server device 100, received data of the media data, and reproduce content based on the stored data (that is, perform streaming reproduction).

Further, the reception information acquisition section 204 of the client device 200 acquires a reception rate which is a data quantity of media data received per unit time by the media data reception section 201 as the transmission rate.

In this example, the reception information acquisition section 204 acquires an instantaneous reception rate which is a value obtained by dividing the data quantity of media data received within a predetermined measurement time by the measurement time, and acquires a value obtained by averaging instantaneous reception rates acquired at a plurality of different points of times as a reception rate. It should be noted that the reception information acquisition section 204 may be adapted to acquire an instantaneous reception rate acquired at a certain point of time as a reception rate. Further, the reception information acquisition section 204 may be adapted to acquire a reception rate based on instantaneous reception rates acquired at a plurality of different points of times and a filter (e.g., a Kalman filter or the like).

Further, the reception information acquisition section 204 acquires a packet loss rate based on the packets received by the media data reception section 201. A packet loss rate is a proportion of the number of packets not received by the client device 200 to the number of packets transmitted from the server device 100. As such, a packet loss rate represents a proportion of occurrence of packet loss. In this example, the reception information acquisition section 204 acquires a packet loss rate based on sequence numbers included in packets.

In this example, the reception information acquisition section 204 acquires an instantaneous packet loss rate within a predetermined measurement time, and acquires a value obtained by averaging instantaneous packet loss rates acquired at a plurality of different points of times as a packet loss rate. It should be noted that the reception information acquisition section 204 may be adapted to acquire an instantaneous packet loss rate acquired at a certain point of time as a packet loss rate. Further, the reception information acquisition section 204 may be adapted to acquire a packet loss rate based on instantaneous packet loss rates acquired at a plurality of different points of times and a filter (e.g., a Kalman filter or the like).

In addition, the reception information acquisition section 204 acquires a media rate of media data received by the media data reception section 201. Then, the reception information acquisition section 204 transmits reception information including the acquired reception rate, media rate, and packet loss rate, to the server device 100.

In addition, the reproduction speed acquisition section 205 of the client device 200 acquires a reproduction speed which is a speed that the content reproduction section 203 reproduces content. Further, the reproduction speed acquisition section 205 transmits a reproduction speed magnification which is a value obtained by dividing the acquired reproduction speed by a reproduction speed corresponding to constant velocity reproduction, to the server device 100.

It should be noted that the reproduction speed magnification is “1” if content is reproduced at a constant velocity, the reproduction speed magnification is “2” if content is reproduced at a reproduction speed two times the constant velocity reproduction (double speed), while the reproduction speed magnification is “0.5” if content is reproduced at a reproduction speed which is a half of the constant-velocity reproduction (slow reproduction).

Further, the remaining reproduction time acquisition section 206 of the client device 200 acquires a remaining reproduction time which is a time in which content can be reproduced at a constant velocity by the content reproduction section 203, based on the portion not having been reproduced of the data (not-reproduced data) stored in the media buffer section 202.

In this example, the remaining reproduction time acquisition section 206 acquires a value obtained by dividing the data quantity of the not-reproduced data by the media rate, as a remaining reproduction time. For example, if the data quantity of the not-reproduced data is 6 [Mega Byte (Mbyte)] (hereinafter, a unit of physical quantity is described in [ ]), and if the media rate of the not-reproduced data is 3 [Mbyte/s (second)], the remaining reproduced time is 2 [s].

It should be noted that if the not-reproduced data consists of a plurality of parts having different media rates from each other, the remaining reproduction time acquisition section 206 acquires the sum of the values each obtained by dividing the data quantity of a part by the media rate thereof, as a remaining reproduction time. For example, if not-reproduced data is data consisting of data having a media rate of 3 [Mbyte/s] and a data quantity of 6 [Mbyte] and data having a media rate of 2 [Mbyte/s] and a data quantity of 6 [Mbyte], the remaining reproduction time acquisition section 206 acquires 2 [s]+3 [s]=5 [s] as a remaining reproduction time.

Further, the remaining reproduction time acquisition section 206 transmits the acquired remaining reproduction time to the server device 100.

It should be noted that in this example, the reception information acquisition section 204, the reproduction speed acquisition section 205, and the remaining reproduction time acquisition section 206 transmit the reception information, the remaining reproduction time, and the reproduction speed magnification in accordance with RTCP (RTP Control Protocol). The reception information acquisition section 204, the reproduction speed acquisition section 205, and the remaining reproduction time acquisition section 206 may be adapted to transmit the reception information, the remaining reproduction time, and the reproduction speed magnification in accordance with a communication protocol other than RTCP.

Further, it is preferable that the reception information acquisition section 204, the reproduction speed acquisition section 205, and the remaining reproduction time acquisition section 206 are adapted to transmit the reception information, the remaining reproduction time, and the reproduction speed magnification with use of arbitrarily extendable APP (Application) packets.

The available bandwidth acquisition section 105 of the server device 100 acquires an available bandwidth. An available bandwidth is a communication bandwidth which can be used for transmitting media data from the server device 100 to the client device 200.

In this example, the available bandwidth acquisition section 105 acquires an available bandwidth based on the reception information received from the reception information acquisition section 204 and the transmission rate of the media data transmission section 104. This means that the available bandwidth acquisition section 105 acquires an available bandwidth by performing passive measurement (e.g., inline measurement).

It should be noted that the available bandwidth acquisition section 105 may be adapted to acquire an available bandwidth by transmitting probe data, which is different from media data, to the client device 200. This means that the available bandwidth acquisition section 105 may be adapted to acquire an available bandwidth by performing active measurement. For example, the available bandwidth acquisition section 105 may use a packet train estimation method (PathLoad, PathChirp, IGI (Initial Gap Increasing), or the like as a method of performing active measurement.

Now, the rate output section 102 of the server device 100 will be described in detail. Based on the available bandwidth, the reproduction speed magnification, the remaining reproduction time, the transmission rate, and the media rate at the current point of time (time t₀), the rate output section 102 outputs optimum values of a combination of a transmission rate and a media rate at a point of time after the current point of time (time t, t>t₀).

As an available bandwidth of the current point of time t₀, the rate output section 102 uses a value acquired by the available bandwidth acquisition section 105. Similarly, the rate output section 102 uses a value received from the reproduction speed acquisition section 205 as a reproduction speed magnification at the current point of time t₀. Similarly, the rate output section 102 uses a value received from the remaining reproduction time acquisition section 206 as a remaining reproduction time at the current point of time t₀. Similarly, the rate output section 102 uses values received from the reception information acquisition section 204 as a transmission rate and a media rate at the current point of time t₀.

Specifically, the rate output section 102 includes a rate candidate extraction section 102a and an optimum rate output section 102b.

The rate candidate extraction section 102a extracts all combinations of transmission rates and media rates satisfying predetermined constraint conditions. As one of the constraint conditions, the rate candidate extraction section 102a uses a condition that a remaining reproduction time Tₚ(t) at a point of time t after the current point of time is larger than 0, as described below.

As such, the rate candidate extraction section 102a uses an analytical solution (expression) of the remaining reproduction time Tₚ(t) represented by a function in which a transmission rate v(t) at a point of time t after the current point of time and a media rate r(t) at a point of time t after the current point of time are used as variables.

Here, derivation of an analytical solution of the remaining reproduction time Tₚ(t) will be described first.

It is assumed that a media rate of media data received by the media data reception section 201 at a time t [s] is r(t) [byte/s] (while [bps] is generally used as a unit of a media rate and a transmission rate, [byte/s] is used in the present description). Similarly, it is assumed that a reception rate (that is, transmission rate) which is a data quantity of media data received by the media data reception section 201 per unit time at the time t [s] is v(t) [byte/s].

Further, it is assumed that a remaining reproduction time which is a time period in which content can be reproduced based on the part not reproduced of the media data stored in the media buffer section 202, at the time t [s], is Tₚ(t) [s]. It is also assumed that a reproduction speed magnification, which is a value obtained by dividing the reproduction speed of content in the content reproduction section 203 by the reproduction speed corresponding to the constant-velocity reproduction at the time t [s], is p(t) [dimensionless].

Here, it is defined that the inverse number of a media rate r(t) is a media density ρ(t) [s/byte], as shown by the following expression (1). A media density represents a time during which content can be reproduced at a constant velocity based on the media data of a unit data quantity.

$$\begin{matrix}[ Expression 1 ] & \\ ρ ( t ) = \frac{1}{r ( t )} & ( 1 )\end{matrix}$$

During the period up to a time t+Δt [s] at which a minute time Δt [s] has passed from the time t[s], a time period in which content can be reproduced at a constant velocity based on the media data received by the media data reception section 201 is represented by the following expression (2).

[Expression 2]

ρ(t)v(t)Δt (2)

On the other hand, during the period up to a time t+Δt [s] at which a minute time Δt [s] has passed from the time t[s], a time period in which content can be reproduced at a constant velocity based on the media data which is the basis of the content reproduced by the content reproduction section 203 is represented by the following expression (3).

[Expression 3]

p(t)Δt (3)

An increase ΔTₚ [s] of the remaining reproduction time, during the period up to a time t+Δt [s] at which a minute time Δt [s] has passed from the time t[s], equals to a value obtained by subtracting the expression (3) from the expression (2). As such, it is represented by the following expression (4).

[Expression 4]

ΔTₚ=ρ(t)v(t)Δt−p(t)Δt (4)

In the expression (4), by taking Δt→0 (taking a limit by approximating Δt to 0), the following differential equation (5) relating to the remaining reproduction time Tₚ is established.

$$\begin{matrix}[ Expression 5 ] & \\ \frac{d {T}_{p}}{d t} = ρ ( t ) v ( t ) - p ( t ) & ( 5 )\end{matrix}$$

In the expression (5), the first term p(t)v(t) in the right hand is set to x(t) as indicated in the following expression (6), and x(t) is called a media flow rate. A media flow rate x(t) [dimensionless] represents a time period in which content can be reproduced at a constant velocity based on the media data received by the media data reception section 201 per unit time. Based on the expression (5) shown above and the expression (6) shown below, a differential equation (7) relating to the remaining reproduction time Tₚ using the media flow rate x(t) is established.

[Expression 6]

x(t)=ρ(t)v(t) (6)

$$\begin{matrix}[ Expression 7 ] & \\ \frac{d {T}_{p}}{d t} = x ( t ) - p ( t ) & ( 7 )\end{matrix}$$

By setting the remaining reproduction time Tₚ(t₀) at the time t₀ [s] to be T₀ and integrating the differential equation (7) within the range from the time t₀ [s] to the time t [s], the remaining reproduction time Tₚ(t) at the time t [s] can be calculated as shown in the following expression (8).

[Expression 8]

Tₚ(t)=T₀+∫ₜ_{₀}^{t}x(τ)dτ−∫ₜ_{₀}^{t}p(τ)dτ (8)

As such, it can be said that the remaining reproduction time Tₚ(t) at the time t [s] is represented by a function in which the value is determined based on the remaining reproduction time T₀ at the current point of time t₀. Further, it can also be said that the remaining reproduction time Tₚ(t) at the time t [s] is represented by a function in which the value is determined based on the reproduction speed magnification ρ(t₀) at the current point of time t₀.

In this example, the rate candidate extraction section 102a uses a value received from the remaining reproduction time acquisition section 206 as the remaining reproduction time T₀. Further, as the reproduction speed magnification ρ(t₀) at the time t₀ [s], the rate candidate extraction section 102a uses a value received from the reproduction speed acquisition section 205.

Further, in this example, the rate candidate extraction section 102a assumes that the reproduction speed magnification p during the period from the time t₀ [s] to the time t [s] is constant at the reproduction speed magnification ρ(t₀) of the time t₀ [s]. It should be noted that the rate candidate extraction section 102a may be adapted to estimate the reproduction speed magnification ρ during the period from the time t₀ [s] to the time t [s] based on the reproduction speed magnification ρ before the time t₀ [s], and use the estimated reproduction speed magnification ρ.

As described above, the rate candidate extraction section 102a extracts all combinations of transmission rates and media rates satisfying the predetermined constraint conditions. In this example, the constraint conditions are conditions which are satisfied when all of the following first to third constraint conditions are met (established).

A first constraint condition is that at a point of time t after the current point of time t₀, a transmission rate v(t) [byte/s] in the media data transmission section 104 of the server device 100 is set to be not larger than an available bandwidth a(t) [byte/s]. The first constraint condition is represented by the following expression (9).

[Expression 9]

v(t)≦a(t)(∀t>t₀) (9)

By satisfying the first constraint condition, a transmission rate v(t) not more than the available bandwidth a(t) can be selected reliably. Accordingly, it is possible to prevent the packets constituting the media data from being discarded (prevent the packets from being lost) within the network. As such, an occurrence of packet loss can be prevented.

In this example, the rate candidate extraction section 102a assumes that the available bandwidth a(t) at the time t [s] after the time t₀ [s] is in conformity with the available bandwidth a(t₀) at the time t₀ [s]. This means that the rate candidate extraction section 102a uses the available bandwidth a(t₀) acquired by the available bandwidth acquisition section 105 at the time t₀ [s], as the available bandwidth a(t) at the time t [s].

It should be noted that the rate candidate extraction section 102a may be adapted to estimate the available bandwidth a(t) at the time t [s] after the time t₀ [s] based on the available bandwidth a before the time t₀ [s], and use the estimated available bandwidth a.

A second constraint condition is that at a point of time t after the current point of time t₀, a media rate r(t) [byte/s] of the media data transmitted by the media data transmission section 104 is set to one of the media rates of the media data stored in the media data storage section 101.

In this example, the media data storage section 101 stores, in advance, media data obtained by encoding content using m (m represents a positive integer) types of media rates (r₁, r₂, . . . rₘ) respectively. Accordingly, the second constraint condition is represented by the following expression (10), where a set R is defined by R={r₁, r₂, . . . , rₘ}.

[Expression 10]

r(t)εR(∀t>t₀) (10)

A third constraint condition is setting a remaining reproduction time Tₚ(t) to be larger at a point of time t (maintaining a remaining reproduction time Tₚ(t) at a value larger than 0 at any time) after the current point of time t₀. The third constraint condition is represented by the following expression (11). Further, the remaining reproduction time Tₚ(t) is represented by the above-described expression (8).

[Expression 11]

Tₚ(t)>0(∀t>t₀) (11)

By satisfying the third constraint condition, combinations of transmission rates v(t) and media rates r(t), with which the remaining reproduction time Tₚ(t) becomes larger than 0, can be selected reliably. Consequently, it is possible to prevent interruption of content reproduction not by an instruction from a user in the client device 200 due to a shortage of media data stored in the media buffer section 202.

As described above, the rate candidate extraction section 102a extracts all combinations of transmission rates v(t) and media rates r(t) satisfying the constraint conditions described above. This means that the rate candidate extraction section 102a extracts all combinations of transmission rates v(t) and media rates r(t) satisfying all of the above-described expression (9), expression (10), and expression (11).

If a set of the combinations of the transmission rates v(t) and the media rates r(t) satisfying the constraint conditions is assumed to be S, a set S is represented by the following expression (12).

[Expression 12]

S={(r,v)|(r,v)ε(satisfy constraint condition)} (12)

The optimum rate output section 102b selects, among combinations of transmission rates v(t) and media rates extracted by the rate candidate extraction section 102, a combination which maximally enhances Quality of Experience. Quality of Experience is a service quality that a user of the client device 200 experiences when viewing content reproduced by the client device 200.

Specifically, the optimum rate output section 102b selects a combination of a transmission rate v(t) and a media rate r(t) corresponding to a Quality of Experience value representing the highest Quality of Experience, based on an objective function J(r,v). An objective function J(r,v) is a function in which a transmission rate v(t) and a media rate r(t) are used as variables respectively and a Quality of Experience value, which is a value representing Quality of Experience, is determined so as to correspond to the variables.

In this example, an objective function J(r,v) is a function constructed based on four parameters including first to fourth parameters.

A first parameter z₁ is a value obtained by subtracting a remaining reproduction time Tₚ(t) at a point of time t after the current point of time T₀, from a target value Tᵣ of a preset remaining reproduction time. A first parameter z₁ is represented by the following expression (13). As described below, in this example, Quality of Experience becomes higher as the value of the objective function J(r,v) (that is, the value of quality of experience) decreases. Further, as the remaining reproduction time Tₚ (t) becomes closer to the target value Tr, the value of the objective function J(r,v) decreases (that is, Quality of Experience becomes higher).

According to this configuration, a combination of a transmission rate v(t) and a media rate r(t), with which the remaining reproduction time Tₚ(t) becomes closer to the target value Tr, is selected in preference. Thereby, it is possible to prevent interruption of reproduction of content not by an instruction from a user in the client device 200, and also prevent the data quantity to be stored in the media buffer section 202 from reaching the capacity of the media buffer section 202 (that is, loss of received media data).

[Expression 13]

z₁=Tᵣ−Tₚ (13)

In this example, the optimum rate output section 102b uses a preset value (e.g., 10 [s], 20 [s], or the like) as a target value Tᵣ. It should be noted that the optimum rate output section 102b may be adapted to set a target value Tᵣ based on the available bandwidth and/or the storage capacity of the media buffer section 202, for example.

A second parameter z₂ is a transmission rate v(t) at a point of time t after the current point of time t₀. The second parameter z₂ is represented by the following expression (14). As described below, in this example, the value of an objective function J(r,v) becomes smaller as the transmission rate v(t) is lowered (that is, Quality of Experience becomes higher).

[Expression 14]

z₂=v (14)

According to this configuration, a lower transmission rate v(t) is selected in preference. It should be noted that as the transmission rate is lowered, the probability of occurrence of convergence in a communication path between the server device 100 and the client device 200 becomes lower. Accordingly, with the above configuration, it is possible to prevent occurrence of packet loss.

As a result, it is possible to reduce the number of packets not received by the client device 200, among the packets constituting the media data transmitted from the server device 100. Accordingly, it is possible to prevent a drop in Quality of Experience.

A third parameter z₃ is a value obtained by subtracting a media rate r(t) at a point of time t after the current point of time t₀, from a maximum value rₘₐₓ of the media rate of the media data stored in the media data storage section 101. The third parameter z₃ is represented by the following expression (15). It should be noted that rₘₐₓ is. As described below, in this example, the value of an objective function J(r,v) becomes smaller (that is, Quality of Experience becomes higher) as the media rate r(t) becomes higher.

[Expression 15]

z₃=rₘₐₓ−r (15)

According to this configuration, a higher media rate r(t) is selected in preference. Thereby, the quality of content (image quality and/or sound quality, for example) can be improved.

A fourth parameter z₄ is a time rate of change (time derivative value) dr/dt of the media rate r(t) at a point of time t after the current point of time. The fourth parameter z₄ is represented by the following expression (16). As described below, in this example, the value of the objective function J(r,v) becomes smaller (that is, Quality of Experience becomes higher) as the time rate of change dr/dt of the media rate r(t) becomes smaller.

$$\begin{matrix}[ Expression 16 ] & \\ {z}_{4} = \frac{d r}{d t} & ( 16 )\end{matrix}$$

It should be noted that if the media rate varies frequently, the clearness of content output by the client device 20 is changed frequently. Consequently, a flicker phenomenon is caused on a display, so that Quality of Experience is lowered.

On the contrary, according to the above configuration, a combination of a transmission rate v(t) and a media rate r(t), with which the time rate of change dr/dt of the media rate r(t) becomes smaller, is selected in preference. Thereby, variations in the media rate can be prevented. As a result, it is possible to prevent a drop in Quality of Experience.

Next, a parameter vector z consisting of the four parameters, described above, will be defined as the following expression (17). In this example, a parameter vector z is a four-dimensional vector.

$$\begin{matrix}[ Expression 17 ] & \\ z = ( \begin{matrix}{z}_{1} \\ {z}_{2} \\ {z}_{3} \\ {z}_{4}\end{matrix} ) & ( 17 )\end{matrix}$$

The objective function J(r,v) is represented by the following expression (18) using a parameter vector z and a positive function L(z). It should be noted that the positive function L(z) is a function in which a parameter vector z is a variable. Further, the positive function L(z) is a function in which L(z)=0 when z=0 while L(z)>0 when z≠0.

[Expression 18]

J=∫ₜ_{₀}^{t}L(z(τ))dτ (18)

As such, it can be said that the objective function J(r,v) is a function in which the value (Quality of Experience value) is determined based on the transmission rate v(t₀) and the media rate r(t₀) at the current point of time t₀.

For example, the objective function J(r,v) may be a function represented by the following expression (19), where A is a positive value matrix.

[Expression 19]

J=∫ₜ_{₀}^{t}z(τ)^{T}Az(τ)dτ (19)

In this case, a diagonal matrix may be used as a positive value matrix A. A diagonal matrix is a square matrix where elements other than diagonal elements are 0. As such, in this case, if the element of a matrix A in the i^{th} row and the j^{th} column is expressed as aᵢⱼ, the element aᵢⱼ where i=j is larger than 0 while the element aᵢⱼ where i≠j is 0. In that case, the objective function J(r,v) is represented by the following expression (20), where an element aᵢⱼ where i=j is expressed as aᵢ.

$$\begin{matrix}[ Expression 20 ] & \\ J = {\int }_{{t}_{0}}^{t} {\sum }_{i = 1}^{4} {a}_{i} {z}_{i}^{2} ( τ ) d τ & ( 20 )\end{matrix}$$

The optimum rate output section 102b selects, among the combinations of the transmission rates v(t) and the media rates r(t) extracted by the rate candidate extraction section 102a, a combination with which the value of the objective function J(r,v) (that is, Quality of Experience value) becomes the smallest (that is, Quality of Experience becomes the highest).

In this example, the optimum rate output section 102b selects a combination of a transmission rate v(t) and a media rate r(t) with use of dynamic programming. It should be noted that the optimum rate output section 102b may be adapted to select a combination of a transmission rate v(t) and a media rate r(t) with use of a method other than dynamic programming.

If a transmission rate v and a media rate r selected by the optimum rate output section 102b are expressed as a transmission rate v* and a media rate r*, the following expression (21) is established.

[Expression 21]

J(r*,v*)≦J(r,v)(∀(r,v)εS) (21)

Then, the optimum rate output section 102b outputs the selected media rate r* to the media packetizing section 103, and outputs the selected transmission rate v* to the media data transmission section 104.

Next, operation of the distribution system 1, described above, will be described specifically.

First, a user of the client device 200 inputs a reproduction request including information for specifying content, to the client device 200. Thereby, the client device 200 transmits a transmission request including information for specifying the content, to the server device 100.

Upon receipt of the transmission request, the server device 100 transmits media data in which the content specified by the transmission request is encoded, to the client device 200. While receiving the media data transmitted from the server device 100, the client device 200 stores received data of the media data into a storage device and also reproduces the content based on the stored data (that is, performs streaming reproduction).

Further, the CPU of the server device 100 is adapted to execute a rate control program shown by the flowchart of FIG. 3 each time a preset control cycle has elapsed.

In more specific, when the CPU begins processing of a rate control program, at step 305, the CPU acquires an available bandwidth a(t₀), a reproduction speed magnification p(t₀), a remaining reproduction time Tp(t₀), a transmission rate v(t₀), and a media rate r(t₀), at the current point of time t₀.

Then, based on the acquired available bandwidth a(t₀), reproduction speed magnification ρ(t₀), remaining reproduction time Tp(t₀), transmission rate v(t₀), and media rate r(t₀), the CPU extracts all combinations of transmission rates v(t) and media rates v(t) satisfying the constraint conditions (step 310). In this example, as a point of time t after the current point of time t₀, the server device 100 uses a point of time t after the current point of time t₀ by a preset time period (e.g., 10 seconds).

Then, among the combinations of the transmission rates v(t) and the media rates r(t) extracted at the step 310, the CPU selects a combination with which the value of the objective function J(r,v) becomes the smallest (that is, Quality of Experience becomes the highest), and outputs the selected combination of a transmission rate v* and a media rate r* (step 315).

Then, the CPU changes the media rate of the media data being transmitted to the client device 200, to the media rate output at the step 315. Further, the CPU also changes the transmission rate which is a data quantity to be transmitted to the client device 200 per unit time, to the transmission rate output at the step 315 (step 320).

Then, the CPU ends the processing of the rate control program.

As described above, according to the first exemplary embodiment of the distribution system of the present invention, the distribution system 1 is able to output a combination of a transmission rate v and a media rate r with which Quality of Experience (QoE) becomes sufficiently high (that is, an appropriate combination). Accordingly, even if the available bandwidth varies, for example, it is possible to prevent a relatively large fluctuation in the media rate r. As such, a drop in Quality of Experience can be prevented.

Further, according to the distribution system 1, it is possible to set an appropriate combination of a transmission rate v and a media rate r quickly, compared with a distribution system which controls a transmission rate v based on the remaining reproduction time and controls a media rate r based on the packet loss rate. Consequently, it is possible to prevent a case where Quality of Experience in a relative low state is maintained for an excessively long period.

As described above, according to the distribution system described above, Quality of Experience can be improved.

Further, according to the first exemplary embodiment, the distribution system 1 outputs, among the combinations of the transmission rates and the media rates satisfying the constraint conditions, a combination of a transmission rate v and a media rate r corresponding to a Quality of Experience value representing the highest Quality of Experience.

According to this configuration, as a combination of a transmission rate v and a media rate r, the distribution system 1 is able to output a combination enabling Quality of Experience to be enhanced as high as possible (a combination enabling Quality of Experience to be the highest among the combinations of the transmission rates and the media rates satisfying the constraint conditions). Consequently, it is possible to further improve Quality of Experience.

It should be noted that in the first exemplary embodiment, the distribution system 1 extracts all combinations of the transmission rates v(t) and the media rates r(t) satisfying the constraint conditions, and then outputs a combination with which the value of the objective function J(r,v) becomes the smallest among the extracted combinations of the transmission rates v(t) and the media rates r(t).

Meanwhile, a distribution system 1, according to a first exemplary modification of the first exemplary embodiment, is adapted to output an optimum combination of a transmission rate v(t) and a media rate r(t) with use of a method which is different from that used by the distribution system 1 according to the first exemplary embodiment.

The distribution system 1 of the first exemplary modification firstly calculates values of an objective function with respect to all combinations of media rates and transmission rates. Then, the distribution system 1 sequentially acquires combinations of media rates and transmission rates in the ascending order from a combination having the smallest calculated value of the objective function, and determines whether or not the acquired combination of a media rate and a transmission rate satisfies the constraint conditions. The distribution system 1 outputs a combination of a media rate and a transmission rate which firstly satisfies the constraint conditions, as an optimum combination.

It should be noted that if an inverse function of the objective function can be obtained, it is possible to specify combinations of media rates and transmission rates in which the values of the objective function are relatively small, without calculating the values of the objective function with respect to all combinations of the media rates and the transmission rates. In that case, the distribution system 1 is able to output an optimum combination of a transmission rate v(t) and a media rate r(t) by performing determination on the specified combinations. Accordingly, the processing load can be reduced in such a case.

Further, a distribution system 1, according to a second exemplary modification of the first exemplary embodiment, is also adapted to output an optimum combination of a transmission rate v(t) and a media rate r(t) with use of a method which is different from that used in the distribution system 1 of the first exemplary embodiment.

The distribution system 1 of this modification uses a function in which the value becomes sufficiently large (e.g., infinite) when the constraint conditions are not satisfied, as an objective function. According to this configuration, the distribution system 1 is able to output an optimum combination of a transmission rate v(t) and a media rate r(t) satisfying the constraint conditions without performing processing of determining whether or not the combination satisfies the constraint conditions.

Further, in the first exemplary embodiment, the distribution system 1 is adapted to extract all combinations of the transmission rates and the media rates satisfying the constraint conditions. Meanwhile, a distribution system 1 according to a third exemplary modification of the first exemplary embodiment may be adapted to extract a part of the combinations of the transmission rates and the media rates satisfying the constraint conditions. With this configuration, it is possible to reduce the processing load for selecting an optimum combination of a transmission rate and a media rate.

Further, in another exemplary modification of the first exemplary embodiment, the constraint condition may be a condition which is satisfied when a part of the first to third constraint conditions is satisfied.

Further, in another exemplary embodiment of the first exemplary embodiment, an objective function J(r, v) may be a function constructed based on partial parameters of the first to fourth parameters.

### Second Exemplary Embodiment

Next, a distribution system according to a second exemplary embodiment of the present invention will be described. The distribution system according to the second exemplary embodiment is different from the distribution system of the first exemplary embodiment in that the client device 200 selects an optimum combination of a transmission rate v(t) and a media rate r(t). As such, description will be given below focusing on such a difference.

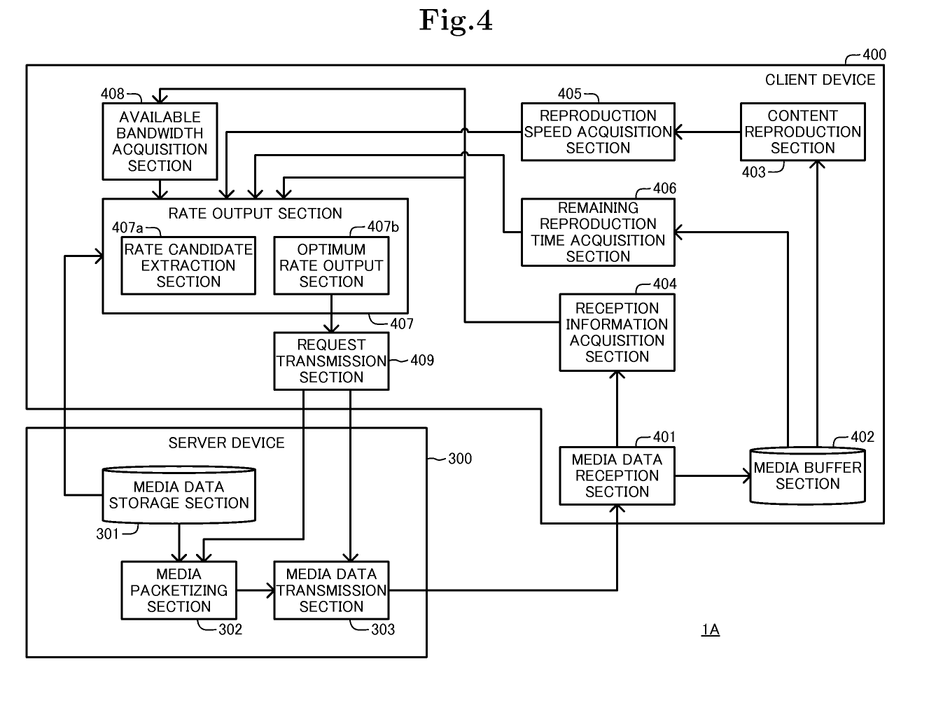

As shown in FIG. 4, a distribution system 1A according to the second exemplary embodiment includes a server device 300 and a client device 400. The server device 300 and the client device 400 are communicably connected with each other over a communication network NW (e.g., the Internet).

The functions of the server device 300 includes a media data storage section (media data storage means) 301, a media packetizing section 302, and a media data transmission section (media data transmission means) 303. The media data storage section 301, the media packetizing section 302, and the media data transmission section 303 respectively have similar functions to those of the media data storage section 101, the media packetizing section 103, and the media data transmission section 104 of the first exemplary embodiment.

Further, the functions of the client device 400 includes a media data reception section 401, a media buffer section 402, a content reproduction section 403, a reception information acquisition section (transmission rate acquisition means, transmission rate transmission means) 404, a reproduction speed acquisition section (reproduction speed acquisition means) 405, a remaining reproduction time acquisition section (remaining reproduction time acquisition means) 406, a rate output section (rate output means) 407, an available bandwidth acquisition section (available bandwidth acquisition means) 408, and a request transmission section (request transmission means) 409. The rate output section 407 includes a rate candidate extraction section 407a and an optimum rate output section 407b.

The functions of the media data reception section 401, the media buffer section 402, the content reproduction section 403, the reception information acquisition section 404, the reproduction speed acquisition section 405, the remaining reproduction time acquisition section 406, the rate output section 407, and the available bandwidth acquisition section 408 are respectively similar to those of the media data reception section 201, the media buffer section 202, the content reproduction section 203, the reception information acquisition section 204, the reproduction speed acquisition section 205, the remaining reproduction time acquisition section 206, the rate output section 102, and the available bandwidth acquisition section 105, of the first exemplary embodiment.

The request transmission section 409 transmits a transmission request to request transmission of the media data, encoded at a media rate r* output by the optimum rate output section 407b, at a transmission rate v* output by the optimum rate output section 407b. This means that the transmission request includes information representing a media rate r* output by the optimum rate output section 407b and a transmission rate v* output by the optimum rate output section 407b.

The media packetizing section 302 of the server device 300 acquires, among the media data stored in the media data storage section 301, a piece of media data encoded at the media rate r* represented by the information included in the transmission request received from the client device 400. Then, the media packetizing section 302 generates packets based on the acquired media data (that is, packetizes the acquired media data).

The media data transmission section 303 of the server device 300 transmits the packets (that is, media data) generated by the media packetizing section 302 to the client device 400 in such a manner that the data quantity to be transmitted per unit time conforms to the transmission rate v* represented by the information included in the transmission request received from the client device 400.

With the distribution system 1A of the second exemplary embodiment, it is also possible to achieve actions and effects similar to those of the first exemplary embodiment.

### Third Exemplary Embodiment

Next, a distribution system according to a third exemplary embodiment of the present invention will be described. The distribution system according to the third exemplary embodiment is different from the distribution system of the first exemplary embodiment in that a relay device, which transfers media data from a server device to a client device, acquires reception information, and transmits the acquired reception information to the server device. Accordingly, description will be given below focusing on such a difference.

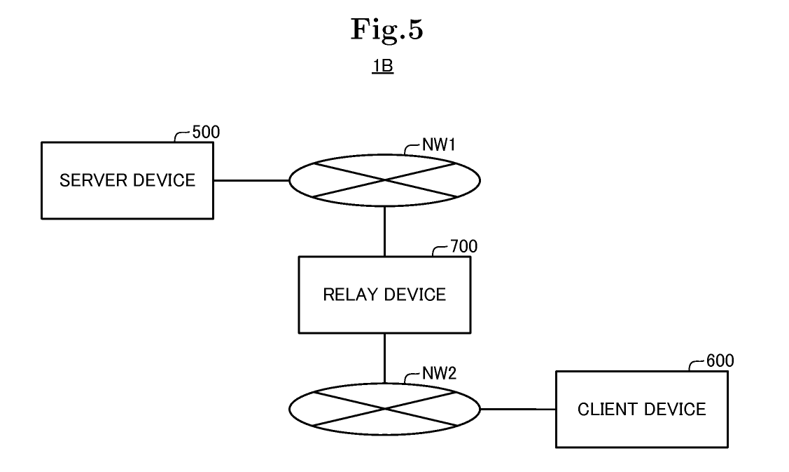

As shown in FIG. 5, a distribution system 1B according to the third exemplary embodiment includes a server device 500, a client device 600, and a relay device 700. The server device 500 and the relay device 700 are communicably connected with each other over a first communication network NW1. Further, the client device 600 and the relay device 700 are communicably connected with each other over a second communication network NW2. As such, the server device 500 and the client device 600 are communicably connected with each other via the relay device 700.

In this example, the client device 600 is a mobile telephone, and the relay device 700 is a base station device. Further, the first communication network NW1 is the Internet, and the second communication network NW2 is a mobile telephone network.

It should be noted that the client device 600 may be electric equipment (for example, a TV receiver, a set top box, or the like) disposed in a house. In that case, the relay device 700 is a home gateway, and the second communication network NW2 is a home network.

The relay device 700 includes a central processing unit (CPU), a storage device (memory), input devices (e.g., keyboard, mouse, and the like), and output devices (e.g., display, speaker, and the like), not shown. The relay device 700 is adapted to realize functions described below by means of execution of programs stored in the storage device by the CPU.

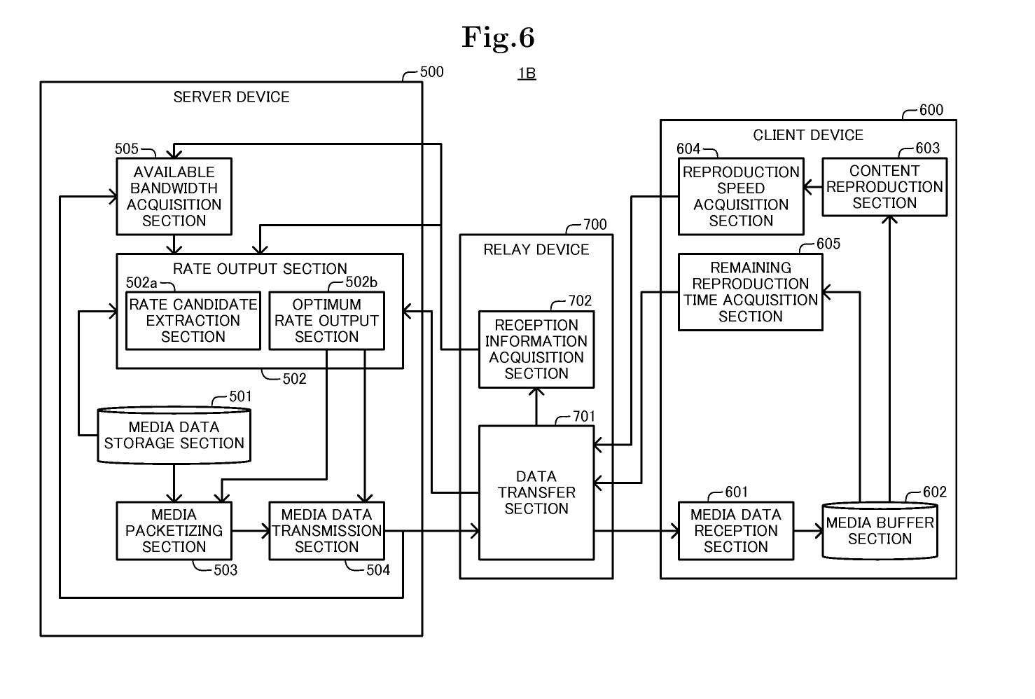

FIG. 6 is a block diagram showing the functions of the distribution system 1B configured as described above. The functions of the server device 500 according to the third exemplary embodiment includes a media data storage section (media data storage means) 501, a rate output section (rate output means) 502, a media packetizing section 503, a media data transmission section (media data transmission means) 504, and an available bandwidth acquisition section (available bandwidth acquisition means) 505, which are similar to the server device 100 of the first exemplary embodiment.

The media data storage section 501, the rate output section 502, the media packetizing section 503, the media data transmission section 504, and the available bandwidth acquisition section 505 respectively have functions similar to those of the media data storage section 101, the rate output section 102, the media packetizing section 103, the media data transmission section 104, and the available bandwidth acquisition section 105 according to the first exemplary embodiment.

Further, the functions of the client device 600 according to the third exemplary embodiment includes a media data reception section 601, a media buffer section 602, a content reproduction section 603, a reproduction speed acquisition section (reproduction speed acquisition means) 604, and a remaining reproduction time acquisition section (remaining reproduction time acquisition means) 605.

The media data reception section 601, the media buffer section 602, the content reproduction section 603, the reproduction speed acquisition section 604, and the remaining reproduction time acquisition section 605 respectively have functions similar to those of the media data reception section 201, the media buffer section 202, the content reproduction section 203, the reproduction speed acquisition section 205, and the remaining reproduction time acquisition section 206 of the first exemplary embodiment.

Further, the functions of the relay device 700 according to the third exemplary embodiment include a data transfer section 701 and a reception information acquisition section (transmission rate acquisition means, transmission rate transmission means) 702.

The data transfer section 701 of the relay device 700 relays communications between the server device 500 and the client device 600. Specifically, the data transfer section 701 receives information, destined for the client device 600, from the server device 500, and transmits (transfers) the reception information to the client device 600.

Further, the media data transmission section 504 transmits media data to the relay device 700.

Accordingly, the data transfer section 701 transfers media data obtained by encoding content, from the server device 500 to be client device 600.

The media data reception section 601 receives the media data transferred by the relay device 700.

Further, the data transfer section 701 receives information, destined for the server device 500, from the client device 600, and transmits (transfers) the reception information to the server device 500.

The reproduction speed acquisition section 604 transmits a reproduction speed magnification to the relay device 700. Further, the remaining reproduction time acquisition section 605 transmits a remaining reproduction time to the relay device 700.

Accordingly, the data transfer section 701 transfers a reproduction speed magnification and a remaining reproduction time from the client device 600 to the server device 500.

The rate output section 502 outputs a combination of a transmission rate and a media rate based on the reproduction speed magnification and the remaining reproduction time received from the relay device 700.

The reception information acquisition section 702 of the relay device 700 acquires a transfer rate, which is a data quantity of media data transferred per unit time from the server device 500 to the client device 600, as a transmission rate.

Further, the reception information acquisition section 702 acquires a packet loss rate based on the packets received from the server device 500. A packet loss rate is a proportion of the number of packets not received by the relay device 700, to the number of packets transmitted from the server device 500. As such, a packet loss rate represents a proportion of occurrence of packet loss. In this example, the reception information acquisition section 702 acquires a packet loss rate based on the sequence numbers included in the packets.

Then, the reception information acquisition section 702 transmits the reception information including the acquired reception rate and packet loss rate to the server device 500.

With the distribution system 1B according to the third exemplary embodiment, it is also possible to achieve actions and effects similar to those of the first exemplary embodiment.

### Fourth Exemplary Embodiment

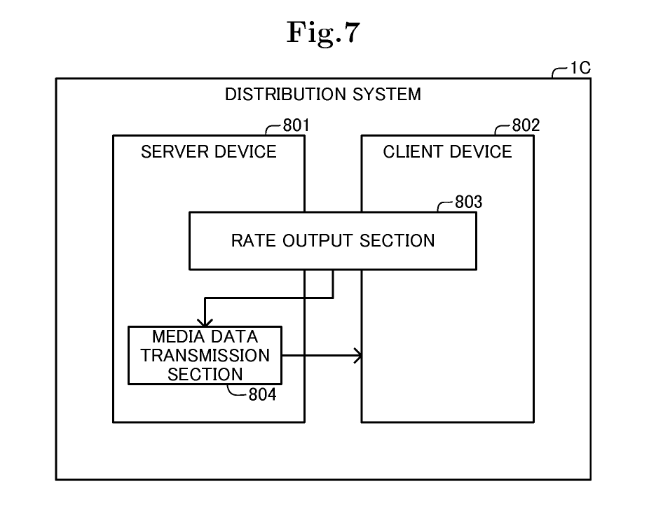

Next, a communication system according to a fourth exemplary embodiment of the present invention will be described with reference to FIG. 7.

A distribution system 1C according to the fourth exemplary embodiment is a system including a server device 801 and a client device 802 which are adapted to be communicable with each other.

The server device 801 is adapted to be able to transmit, to the client device 802, media data which is formed by encoding content at an arbitrary media rate among a plurality of different media rates.

The client device 802 is adapted to, while receiving the media data transmitted by the server device 801, store received data of the media data in a storage device and reproduce the content based on the stored data.

The distribution system 1C further includes:

a rate output section (rate output means) 803 for outputting a combination of a transmission rate and a media rate based on an objective function, the objective function being a function in which a transmission rate representing a data quantity of the media data transmitted by the server device 801 per unit time and the media rate respectively serve as variables, and also a function in which a Quality of Experience value is determined so as to correspond to the variables, the Quality of Experience value being a value representing Quality of Experience which is a service quality experienced by a user of the client device 802 when the user views the content reproduced by the client device 802, and

a media data transmission section (media data transmission means) 804 for transmitting, by the server device 801, the media data encoded at the selected media rate, to the client device 802 at the selected transmission rate.

According to this configuration, the distribution system 1C is able to output a combination of a transmission rate and a media rate with which Quality of Experience (QoE) becomes sufficiently high (that is, an appropriate combination). Accordingly, even if the available bandwidth varies, for example, it is possible to prevent a relatively large fluctuation in the media rate. As such, a drop in Quality of Experience can be prevented.

Further, according to the distribution system 1C, it is possible to set an appropriate combination of a transmission rate and a media rate quickly, compared with a distribution system which controls a transmission rate based on the remaining reproduction time and controls a media rate based on the packet loss rate. Consequently, it is possible to prevent a case where Quality of Experience in a relative low state is maintained for an excessively long period.

As described above, according to the distribution system 1C, Quality of Experience can be improved.

In that case, it is preferable that the rate output means is adapted to output a combination of the transmission rate and the media rate corresponding to a Quality of Experience value representing the highest Quality of Experience, among combinations of the transmission rates and the media rates satisfying a predetermined constraint condition.

According to this configuration, as a combination of a transmission rate and a media rate, the distribution system is able to output a combination enabling Quality of Experience to be enhanced as high as possible (a combination enabling Quality of Experience to be the highest among the combinations of the transmission rates and the media rates satisfying the constraint condition). Consequently, it is possible to further improve Quality of Experience.
In that case, it is preferable that the objective function is set such that Quality of Experience represented by the Quality of Experience value improves as the transmission rate becomes lower.

According to this configuration, a lower transmission rate is output in preference. Thereby, occurrence of packet loss can be prevented. As a result, it is possible to reduce the number of packets not received by the client device, among the packets constituting the media data transmitted from the server device. Accordingly, it is possible to prevent a drop in Quality of Experience due to a loss of media data. As such, Quality of Experience can be improved reliably.

In that case, it is preferable that the objective function is set such that Quality of Experience represented by the Quality of Experience value improves as the media rate becomes higher.

According to this configuration, a higher media rate is output in preference. Thereby, the quality of content (image quality and/or sound quality, for example) can be improved.

In that case, it is preferable that the objective function is set such that Quality of Experience represented by the Quality of Experience value improves as a time rate of change of the media rate becomes smaller.

According to this configuration, a combination of a transmission rate and a media rate, with which a time rate of change of the media rate becomes smaller, is output in preference. Thereby, variations in the media rate can be prevented. As a result, Quality of Experience can be improved reliably.

In that case, it is preferable that the objective function is set such that Quality of Experience represented by the Quality of Experience value improves as a remaining reproduction time becomes closer to a preset target value, the remaining reproduction time being a time period in which the content is able to be reproduced based on a not-reproduced portion of the data stored in the storage device of the client device.

According to this configuration, a combination of a transmission rate and a media rate, with which the remaining reproduction time becomes closer to a target value, is output in preference. Thereby, it is possible to prevent interruption of reproduction of content not by an instruction from a user in the client device, and also prevent the data quantity to be stored in the storage device of the client device from reaching the capacity of the storage device (that is, loss of received media data). As a result, Quality of Experience can be improved reliably.

In that case, it is preferable that the remaining reproduction time is represented by a function in which a value is determined based on the remaining reproduction time at a point of time before the current point of time, and that the distribution system further includes a remaining reproduction time acquisition means for acquiring the remaining reproduction time at a point of time before the current point of time.

In that case, it is preferable that the remaining reproduction time is represented by a function in which a value is determined based on a reproduction speed which is a speed of reproducing the content by the client device at a point of time before the current point of time, and that the distribution system further includes a reproduction speed acquisition means for acquiring the reproduction speed at a point of time before the current point of time.

According to this configuration, even if content is reproduced at a reproduction speed which is different from the case where the content is reproduced at a constant velocity (reproduced at a single speed) (e.g., double-speed reproduction, slow reproduction, or the like), the remaining reproduction time can be calculated with high accuracy.

In that case, it is preferable that the distribution system includes an available bandwidth acquisition means for acquiring an available bandwidth which is a communication bandwidth usable for transmitting the media data from the server device to the client device, and that the constraint condition includes a condition that the transmission rate is not larger than the acquired available bandwidth.

According to this configuration, a transmission rate not larger than the available bandwidth can be output reliably. Consequently, occurrence of packet loss can be prevented. As a result, Quality of Experience can be improved reliably.

In that case, it is preferable that the constraint condition includes a condition that a remaining reproduction time is larger than 0, the remaining reproduction time being a time period in which the content is able to be reproduced based on a not-reproduced portion of the data stored in the storage device of the client device.

According to this configuration, a combination of a transmission rate and a media rate, with which the remaining reproduction time is larger than 0, is output reliably. Thereby, it is possible to prevent interruption of reproduction of content not by an instruction from a user in the client device. As a result, Quality of Experience can be improved reliably.

In that case, it is preferable that the distribution system includes a media data storage means for storing media data formed by encoding the content at the plurality of media rates respectively, that

the media data transmission means is adapted to transmit, by the server device, the media data stored in the media data storage means to the client device, and that
the constraint condition includes a condition that the media rate is one of the plurality of media rates.

In that case, it is preferable that the objective function is a function in which the Quality of Experience value is determined based on the transmission rate at a point of time before the current point of time, and that

the distribution system further includes a transmission rate acquisition means for acquiring the transmission rate at a point of time before the current point of time.

In that case, it is preferable that the client device includes

the transmission rate acquisition means for acquiring, as the transmission rate, a reception rate which is a data quantity of the media data received per unit time from the server device, and

a transmission rate transmission means for transmitting the acquired transmission rate to the server device.

Further, it is preferable that a distribution system, according to another aspect of the present invention, includes a relay device which transfers the media data from the server device to the client device, and that

the relay device includes:

the transmission rate acquisition means for acquiring, as the transmission rate, a transfer rate which is a data quantity of the media data transferred per unit time from the server device to the client device; and

a transmission rate transmission means for transmitting the acquired transmission rate to the server device.

Further, a distribution method, which is another aspect of the present invention, is a method applied to a distribution system including a server device and a client device which are adapted to be communicable with each other.

The server device is adapted to be able to transmit, to the client device, media data which is formed by encoding content at an arbitrary media rate among a plurality of different media rates.

The client device is adapted to, while receiving the media data transmitted by the server device, store received data of the media data in a storage device and reproduce the content based on the stored data.

The distribution method includes:

outputting a combination of a transmission rate and a media rate based on an objective function, the objective function being a function in which a transmission rate representing a data quantity of the media data transmitted by the server device per unit time and the media rate respectively serve as variables, and also a function in which a Quality of Experience value is determined so as to correspond to the variables, the Quality of Experience value being a value representing Quality of Experience which is a service quality experienced by a user of the client device when the user views the content reproduced by the client device, and

transmitting, by the server device, the media data encoded at the output media rate, to the client device at the output transmission rate.

In that case, it is preferable that the distribution method includes

outputting a combination of the transmission rate and the media rate corresponding to a Quality of Experience value representing the highest Quality of Experience, among combinations of the transmission rates and the media rates satisfying a predetermined constraint condition.

In that case, it is preferable that the objective function is set such that Quality of Experience represented by the Quality of Experience value improves as the transmission rate becomes lower.

In that case, it is preferable that the objective function is set such that Quality of Experience represented by the Quality of Experience value improves as the media rate becomes higher.

In that case, it is preferable that the objective function is set such that Quality of Experience represented by the Quality of Experience value improves as a time rate of change of the media rate becomes smaller.

In that case, it is preferable that the objective function is set such that Quality of Experience represented by the Quality of Experience value improves as a remaining reproduction time becomes closer to a preset target value, the remaining reproduction time being a time period in which the content is able to be reproduced based on a not-reproduced portion of the data stored in the storage device of the client device.

In that case, it is preferable that the remaining reproduction time is represented by a function in which a value is determined based on the remaining reproduction time at a point of time before a current point of time, and that

the distribution method further includes acquiring the remaining reproduction time at a point of time before the current point of time.

In that case, it is preferable that the remaining reproduction time is represented by a function in which a value is determined based on a reproduction speed which is a speed of reproducing the content by the client device at a point of time before the current point of time, and that

the distribution method further includes acquiring the reproduction speed at a point of time before the current point of time.

In that case, it is preferable that the distribution method includes acquiring an available bandwidth which is a communication bandwidth usable for transmitting the media data from the server device to the client device, and that

the constraint condition includes a condition that the transmission rate is not larger than the acquired available bandwidth.

In that case, it is preferable that the constraint condition includes a condition that a remaining reproduction time is larger than 0, the remaining reproduction time being a time period in which the content is able to be reproduced based on a not-reproduced portion of the data stored in the storage device of the client device.

In that case, it is preferable that the distribution method includes transmitting, by the server device, media data stored in a storage device which stores media data formed by encoding the content at the plurality of media rates respectively, to the client device, and that

the constraint condition includes a condition that the media rate is one of the plurality of media rates.

In that case, it is preferable that the objective function is a function in which the Quality of Experience value is determined based on the transmission rate at a point of time before the current point of time, and that

the distribution method further includes acquiring the transmission rate at a point of time before the current point of time.

In that case, in the distribution method, it is preferable that the client device acquires, as the transmission rate, a reception rate which is a data quantity of the media data received per unit time from the server device, and that

the client device transmits the acquired transmission rate to the server device.

Further, according to another aspect of the distribution method, it is preferable that the distribution system includes a relay device which transfers the media data from the server device to the client device, and that

in the distribution method, the relay device acquires, as the transmission rate, a transfer rate which is a data quantity of the media data transferred per unit time from the server device to the client device; and the relay device transmits the acquired transmission rate to the server device.

Further, a server device, which is another aspect of the present invention, is a device adapted to be communicable with a client device.

The server device is adapted to be able to transmit, to the client device, media data which is formed by encoding content at an arbitrary media rate among a plurality of different media rates, and includes:

a rate output means for outputting a combination of a transmission rate and a media rate based on an objective function, the objective function being a function in which a transmission rate representing a data quantity of the media data transmitted by the server device per unit time and the media rate respectively serve as variables, and also a function in which a Quality of Experience value is determined so as to correspond to the variables, the Quality of Experience value being a value representing Quality of Experience which is a service quality experienced by a user of the client device when the user views the content reproduced by the client device, and

a media data transmission means for transmitting the media data encoded at the output media rate, to the client device at the output transmission rate.

In that case, it is preferable that the rate output means is adapted to output a combination of the transmission rate and the media rate corresponding to a Quality of Experience value representing the highest Quality of Experience, among combinations of the transmission rates and the media rates satisfying a predetermined constraint condition.

Further, a program, which is another aspect of the present invention, is a program for causing a server device to realize, the server device being adapted to be communicable with a client device and also adapted to be able to transmit, to the client device, media data which is formed by encoding content at an arbitrary media rate among a plurality of different media rates:

a rate output means for outputting a combination of a transmission rate and a media rate based on an objective function, the objective function being a function in which a transmission rate representing a data quantity of the media data transmitted by the server device per unit time and the media rate respectively serve as variables, and also a function in which a Quality of Experience value is determined so as to correspond to the variables, the Quality of Experience value being a value representing Quality of Experience which is a service quality experienced by a user of the client device when the user views the content reproduced by the client device, and

a media data transmission means for transmitting the media data encoded at the output media rate, to the client device at the output transmission rate.

Further, a client device, which is another aspect of the present invention is a device adapted to be communicable with a server device which is adapted to be able to transmit, to the client device, media data formed by encoding content at an arbitrary media rate among a plurality of different media rates.

The client device is also adapted to, while receiving the media data transmitted by the server device, store received data of the media data in a storage device and reproduce the content based on the stored data, and includes

a rate output means for outputting a combination of a transmission rate and a media rate based on an objective function, the objective function being a function in which a transmission rate representing a data quantity of the media data transmitted by the server device per unit time and the media rate respectively serve as variables, and also a function in which a Quality of Experience value is determined so as to correspond to the variables, the Quality of Experience value being a value representing Quality of Experience which is a service quality experienced by a user of the client device when the user views the content reproduced by the client device, and

a request transmission means for transmitting, to the server device, a transmission request which is a request to transmit the media data encoded at the output media rate, at the output transmission rate.

In that case, it is preferable that the rate output means is adapted to output a combination of the transmission rate and the media rate corresponding to a Quality of Experience value representing the highest Quality of Experience, among combinations of the transmission rates and the media rates satisfying a predetermined constraint condition.

Further, a program, which is another aspect of the present invention, is a program for causing a client device to realize, the client device being adapted to be communicable with a server device which is adapted to be able to transmit, to the client device, media data formed by encoding content at an arbitrary media rate among a plurality of different media rates, the client device being also adapted to, while receiving the media data transmitted by the server device, store received data of the media data in a storage device and reproduce the content based on the stored data:

a rate output means for outputting a combination of a transmission rate and a media rate based on an objective function, the objective function being a function in which a transmission rate representing a data quantity of the media data transmitted by the server device per unit time and the media rate respectively serve as variables, and also being a function in which a Quality of Experience value is determined so as to correspond to the variables, the Quality of Experience value being a value representing Quality of Experience which is a service quality experienced by a user of the client device when the user views the content reproduced by the client device, and

a request transmission means for transmitting, to the server device, a transmission request which is a request to transmit the media data encoded at the output media rate, at the output transmission rate.

Further, a distribution control method, which is another aspect of the present invention, is a method for controlling transmission of media data, formed by encoding content, from a server device to a client device.

The distribution control method includes outputting a combination of a transmission rate and a media rate based on an objective function, the objective function being a function in which a transmission rate representing a data quantity of the media data transmitted by the server device per unit time and a media rate representing a data quantity of the media data for reproducing the content per unit time respectively serve as variables, and also a function in which a Quality of Experience value is determined so as to correspond to the variables, the Quality of Experience value being a value representing Quality of Experience which is a service quality experienced by a user of the client device when the user views the content reproduced by the client device.

Further, a relay device, which is another aspect of the present invention, is a device adapted to be communicable with a server device and with a client device.

The relay device is also adapted to transfer media data, formed by encoding content, from the server device to the client device, and includes

a transmission rate acquisition means for acquiring, as a transmission rate, a transfer rate which is a data quantity of the media data transferred per unit time from the server device to the client device, and

a transmission rate transmission means for transmitting the acquired transmission rate to the server device.

Further, a relay method, which is another aspect of the present invention, is a method applied to a relay device adapted to be communicable with a server device and with a client device.

The relay method includes

transferring media data, formed by encoding content, from the server device to the client device;

acquiring, as a transmission rate, a transfer rate which is a data quantity of the media data transferred per unit time from the server device to the client device; and

transmitting the acquired transmission rate to the server device.

Further, a program, which is another aspect of the present invention, is a program for causing a relay device to realize, the relay device being adapted to be communicable with a server device and with a client device and also adapted to transfer media data, formed by encoding content, from the server device to the client device:

a transmission rate acquisition means for acquiring, as a transmission rate, a transfer rate which is a data quantity of the media data transferred per unit time from the server device to the client device, and

a transmission rate transmission means for transmitting the acquired transmission rate to the server device.

As an invention of a distribution method, a server device, a program, a client device, a distribution control method, a relay device, or a relay method having the configuration described above also has actions similar to those of the above-described distribution system, such an invention is able to achieve the object of the present invention.

While the present invention has been described with reference to the exemplary embodiments thereof, the present invention is not limited to the above-described exemplary embodiments. It will be understood by those skilled in the art that various changes in form and details may be made therein without departing from the scope of the present invention as defined in the claims.

For example, although the objective function is set such that Quality of Experience improves as the value of the objective function (that is, Quality of Experience value) becomes smaller in each of the exemplary embodiments, the objective function may be set such that Quality of Experience improves as the value of the objective function becomes larger. In that case, the distribution system may use a function in which the right hand of the expressions (18) to (20) is multiplied by “−1”, as an objective function.

Further, in the respective exemplary embodiments, the distribution systems 1 to 1C are adapted to output optimum values of a combination of a transmission rate and a media rate at a point of time (time t) after the current point of time, based on the available bandwidth, the reproduction speed magnification, the remaining reproduction time, the transmission rate, and the media rate at the current point of time (time t₀). Meanwhile, in exemplary modifications of the respective exemplary embodiment, the distribution system may be adapted to output optimum values of a combination of a transmission rate and a media rate at a point of time (time t) after the current point of time, based on the available bandwidth, the reproduction speed magnification, the remaining reproduction time, the transmission rate, and the media rate, at a point of time (time tₚ, tₚ<t₀) before the current point of time (time t₀).

It should be noted that in the respective exemplary embodiments, while the respective functions of the distribution systems 1 to 1C are realized by means of execution of programs (software) by the CPU, they may be realized by hardware such as circuits.

Further, while the programs are stored in storage devices in the respective exemplary embodiments, they may be stored in computer-readable recording media. For example, recording media are portable media including flexible disks, optical disks, magneto-optical disks, semiconductor memories, and the like.

Further, as other exemplary modifications of the above-described exemplary embodiments, any combinations of the exemplary embodiments and the exemplary modifications may be adopted.

This application is based upon and claims the benefit of priority from Japanese patent application No. 2009-186118, filed on Aug. 10, 2009, the disclosure of which is incorporated herein in its entirety by reference.

### INDUSTRIAL APPLICABILITY

The present invention is applicable to a distribution system including a server device which distributes media data representing content and a client device which receives media data from the server device, and the like.

### REFERENCE NUMERALS

1 distribution system
100 server device
101 media data storage section
102 rate output section
102a rate candidate extraction section
102b optimum rate output section
103 media packetizing section
104 media data transmission section
105 available bandwidth acquisition section
200 client device
201 media data reception section
202 media buffer section
203 content reproduction section
204 reception information acquisition section
205 reproduction speed acquisition section
206 remaining reproduction time acquisition section
1A distribution system
300 server device
301 media data storage section
302 media packetizing section
303 media data transmission section
400 client device
401 media data reception section
402 media buffer section
403 content reproduction section
404 reception information acquisition section
405 reproduction speed acquisition section
406 remaining reproduction time acquisition section
407 rate output section
407a rate candidate extraction section
407b optimum rate output section
408 available bandwidth acquisition section
409 request transmission section
1B distribution system
500 server device
501 media data storage section
502 rate output section
503 media packetizing section
504 media data transmission section
505 available bandwidth acquisition section
600 client device
601 media data reception section
602 media buffer section
603 content reproduction section
604 reproduction speed acquisition section
605 remaining reproduction time acquisition section
700 relay device
701 data transfer section
702 reception information acquisition section
1C distribution system
801 server device
802 client device
803 rate output section
804 media data transmission section
NW communication network
NW1 first communication network
NW2 second communication network

1. A distribution system comprising a server device and a client device which are adapted to be communicable with each other, wherein
the server device is adapted to be able to transmit, to the client device, media data which is formed by encoding content at an arbitrary media rate among a plurality of different media rates,
the client device is adapted to, while receiving the media data transmitted by the server device, store received data of the media data in a storage device and reproduce the content based on the stored data, and
the distribution system further comprises:
a rate output unit that outputs a combination of a transmission rate and a media rate based on an objective function, the objective function being a function in which a transmission rate representing a data quantity of the media data transmitted by the server device per unit time and the media rate respectively serve as variables, and also a function in which a Quality of Experience value is determined so as to correspond to the variables, the Quality of Experience value being a value representing Quality of Experience which is a service quality experienced by a user of the client device when the user views the content reproduced by the client device, and
a media data transmission unit that transmits, by the server device, the media data encoded at the output media rate, to the client device at the output transmission rate.

2. The distribution system according to claim 1, wherein
the rate output unit is adapted to output a combination of the transmission rate and the media rate corresponding to a Quality of Experience value representing the highest Quality of Experience, among combinations of the transmission rate and the media rate satisfying a predetermined constraint condition.

3. The distribution system according to claim 1, wherein
the objective function is set such that Quality of Experience represented by the Quality of Experience value improves as the transmission rate becomes lower.

4. The distribution system according to claim 1, wherein
the objective function is set such that Quality of Experience represented by the Quality of Experience value improves as the media rate becomes higher.

5. The distribution system according to claim 1, wherein
the objective function is set such that Quality of Experience represented by the Quality of Experience value improves as a time rate of change of the media rate becomes smaller.

6. The distribution system according to claim 1, wherein
the objective function is set such that Quality of Experience represented by the Quality of Experience value improves as a remaining reproduction time becomes closer to a preset target value, the remaining reproduction time being a time period in which the content is able to be reproduced based on a not-reproduced portion of the data stored in the storage device of the client device.

7. The distribution system according to claim 6, wherein
the remaining reproduction time is represented by a function in which a value is determined based on the remaining reproduction time at a point of time before a current point of time, and
the distribution system further comprises a remaining reproduction time acquisition unit that acquires the remaining reproduction time at a point of time before the current point of time.

8. The distribution system according to claim 6, wherein
the remaining reproduction time is represented by a function in which a value is determined based on a reproduction speed which is a speed of reproducing the content by the client device at a point of time before the current point of time, and
the distribution system further comprises a reproduction speed acquisition unit that acquires the reproduction speed at a point of time before the current point of time.

9. The distribution system according to claim 2, further comprising
an available bandwidth acquisition unit that acquires an available bandwidth which is a communication bandwidth usable for transmitting the media data from the server device to the client device, wherein
the constraint condition includes a condition that the transmission rate is not larger than the acquired available bandwidth.

10. The distribution system according to claim 2, wherein
the constraint condition includes a condition that a remaining reproduction time is larger than 0, the remaining reproduction time being a time period in which the content is able to be reproduced based on a not-reproduced portion of the data stored in the storage device of the client device.

11. The distribution system according to claim 2, further comprising
a media data storage unit that stores media data formed by encoding the content at the plurality of media rates respectively, wherein
the media data transmission unit is adapted to transmit, by the server device, the media data stored in the media data storage unit to the client device, and
the constraint condition includes a condition that the media rate is one of the plurality of media rates.

12. The distribution system according to claim 1, wherein
the objective function is a function in which the Quality of Experience value is determined based on the transmission rate at a point of time before the current point of time, and
the distribution system further comprises a transmission rate acquisition unit that acquires the transmission rate at a point of time before the current point of time.

13. The distribution system according to claim 12, wherein
the client device includes
the transmission rate acquisition unit that acquires, as the transmission rate, a reception rate which is a data quantity of the media data received per unit time from the server device, and
a transmission rate transmission unit that transmits the acquired transmission rate to the server device.

14. The distribution system according to claim 12, further comprising
a relay device which transfers the media data from the server device to the client device, wherein
the relay device includes:
the transmission rate acquisition unit that acquires, as the transmission rate, a transfer rate which is a data quantity of the media data transferred per unit time from the server device to the client device, and
a transmission rate transmission unit that transmits the acquired transmission rate to the server device.

15. A distribution method applied to a distribution system including a server device and a client device which are adapted to be communicable with each other,
the server device being adapted to be able to transmit, to the client device, media data which is formed by encoding content at an arbitrary media rate among a plurality of different media rates,
the client device being adapted to, while receiving the media data transmitted by the server device, store received data of the media data in a storage device and reproduce the content based on the stored data,
the method comprising:
outputting a combination of a transmission rate and a media rate based on an objective function, the objective function being a function in which a transmission rate representing a data quantity of the media data transmitted by the server device per unit time and the media rate respectively serve as variables, and also a function in which a Quality of Experience value is determined so as to correspond to the variables, the Quality of Experience value being a value representing Quality of Experience which is a service quality experienced by a user of the client device when the user views the content reproduced by the client device, and
transmitting, by the server device, the media data encoded at the output media rate, to the client device at the output transmission rate.

16. The distribution method according to claim 15, further comprising
outputting a combination of the transmission rate and the media rate corresponding to a Quality of Experience value representing the highest Quality of Experience, among combinations of the transmission rate and the media rate satisfying a predetermined constraint condition.

17. The distribution method according to claim 15, wherein
the objective function is set such that Quality of Experience represented by the Quality of Experience value improves as the transmission rate becomes lower.

18. The distribution method according to claim 15, wherein
the objective function is set such that Quality of Experience represented by the Quality of Experience value improves as the media rate becomes higher.

19. The distribution method according to claim 15, wherein
the objective function is set such that Quality of Experience represented by the Quality of Experience value improves as a time rate of change of the media rate becomes smaller.

20. The distribution method according to claim 15, wherein
the objective function is set such that Quality of Experience represented by the Quality of Experience value improves as a remaining reproduction time becomes closer to a preset target value, the remaining reproduction time being a time period in which the content is able to be reproduced based on a not-reproduced portion of the data stored in the storage device of the client device.

21. The distribution method according to claim 20, wherein
the remaining reproduction time is represented by a function in which a value is determined based on the remaining reproduction time at a point of time before a current point of time, and
the distribution method further comprises acquiring the remaining reproduction time at a point of time before the current point of time.

22. The distribution method according to claim 20, wherein
the remaining reproduction time is represented by a function in which a value is determined based on a reproduction speed which is a speed of reproducing the content by the client device at a point of time before the current point of time, and
the distribution method further comprises acquiring the reproduction speed at a point of time before the current point of time.

23. The distribution method according to claim 16, further comprising
acquiring an available bandwidth which is a communication bandwidth usable for transmitting the media data from the server device to the client device, wherein
the constraint condition includes a condition that the transmission rate is not larger than the acquired available bandwidth.

24. The distribution method according to claim 16, wherein
the constraint condition includes a condition that a remaining reproduction time is larger than 0, the remaining reproduction time being a time period in which the content is able to be reproduced based on a not-reproduced portion of the data stored in the storage device of the client device.

25. The distribution method according to claim 16, further comprising
transmitting, by the server device, media data stored in a storage device which stores media data formed by encoding the content at the plurality of media rates respectively, to the client device, wherein
the constraint condition includes a condition that the media rate is one of the plurality of media rates.

26. The distribution method according to claim 15, wherein
the objective function is a function in which the Quality of Experience value is determined based on the transmission rate at a point of time before the current point of time, and
the distribution method further comprises acquiring the transmission rate at a point of time before the current point of time.

27. The distribution method according to claim 26, comprises
by the client device, acquiring, as the transmission rate, a reception rate which is a data quantity of the media data received per unit time from the server device, and
by the client device, transmitting the acquired transmission rate to the server device.

28. The distribution method according to claim 26, wherein
the distribution system includes a relay device which transfers the media data from the server device to the client device,
the distribution method comprises
by the relay device, acquiring, as the transmission rate, a transfer rate which is a data quantity of the media data transferred per unit time from the server device to the client device; and
by the relay device, transmitting the acquired transmission rate to the server device.

29. A server device adapted to be communicable with a client device,
the server device being adapted to be able to transmit, to the client device, media data which is formed by encoding content at an arbitrary media rate among a plurality of different media rates, the server device comprising:
a rate output unit that outputs a combination of a transmission rate and a media rate based on an objective function, the objective function being a function in which a transmission rate representing a data quantity of the media data transmitted by the server device per unit time and the media rate respectively serve as variables, and also a function in which a Quality of Experience value is determined so as to correspond to the variables, the Quality of Experience value being a value representing Quality of Experience which is a service quality experienced by a user of the client device when the user views the content reproduced by the client device, and
a media data transmission unit that transmits the media data encoded at the output media rate, to the client device at the output transmission rate.

30. The server device according to claim 29, wherein
the rate output unit is adapted to output a combination of the transmission rate and the media rate corresponding to a Quality of Experience value representing the highest Quality of Experience, among combinations of the transmission rate and the media rate satisfying a predetermined constraint condition.

31. A computer-readable medium storing a program comprising instructions for causing a server device to realize, the server device being adapted to be communicable with a client device and also adapted to be able to transmit, to the client device, media data which is formed by encoding content at an arbitrary media rate among a plurality of different media rates:
a rate output unit that outputs a combination of a transmission rate and a media rate based on an objective function, the objective function being a function in which a transmission rate representing a data quantity of the media data transmitted by the server device per unit time and the media rate respectively serve as variables, and also a function in which a Quality of Experience value is determined so as to correspond to the variables, the Quality of Experience value being a value representing Quality of Experience which is a service quality experienced by a user of the client device when the user views the content reproduced by the client device, and
a media data transmission unit that transmits the media data encoded at the output media rate, to the client device at the output transmission rate.

32. A client device adapted to be communicable with a server device which is adapted to be able to transmit, to the client device, media data which is formed by encoding content at an arbitrary media rate among a plurality of different media rates,
the client device being adapted to, while receiving the media data transmitted by the server device, store received data of the media data in a storage device and reproduce the content based on the stored data,
the client device comprising:
a rate output unit that outputs a combination of a transmission rate and a media rate based on an objective function, the objective function being a function in which a transmission rate representing a data quantity of the media data transmitted by the server device per unit time and the media rate respectively serve as variables, and also a function in which a Quality of Experience value is determined so as to correspond to the variables, the Quality of Experience value being a value representing Quality of Experience which is a service quality experienced by a user of the client device when the user views the content reproduced by the client device, and
a request transmission unit that transmits, to the server device, a transmission request which is a request to transmit the media data encoded at the output media rate, at the output transmission rate.

33. The client device according to claim 32, wherein
the rate output unit is adapted to output a combination of the transmission rate and the media rate corresponding to a Quality of Experience value representing the highest Quality of Experience, among combinations of the transmission rate and the media rate satisfying a predetermined constraint condition.

34. A computer-readable medium storing a program comprising instructions for causing a client device to realize, the client device being adapted to be communicable with a server device which is adapted to be able to transmit, to the client device, media data formed by encoding content at an arbitrary media rate among a plurality of different media rates, the client device being also adapted to, while receiving the media data transmitted by the server device, store received data of the media data in a storage device and reproduce the content based on the stored data:
a rate output unit that outputs a combination of a transmission rate and a media rate based on an objective function, the objective function being a function in which a transmission rate representing a data quantity of the media data transmitted by the server device per unit time and the media rate respectively serve as variables, and also being a function in which a Quality of Experience value is determined so as to correspond to the variables, the Quality of Experience value being a value representing Quality of Experience which is a service quality experienced by a user of the client device when the user views the content reproduced by the client device, and
a request transmission unit that transmits, to the server device, a transmission request which is a request to transmit the media data encoded at the output media rate, at the output transmission rate.

35. A distribution control method for controlling transmission of media data, formed by encoding content, from a server device to a client device, the method comprising
outputting a combination of a transmission rate and a media rate based on an objective function, the objective function being a function in which a transmission rate representing a data quantity of the media data transmitted by the server device per unit time and a media rate representing a data quantity of the media data for reproducing the content per unit time respectively serve as variables, and also a function in which a Quality of Experience value is determined so as to correspond to the variables, the Quality of Experience value being a value representing Quality of Experience which is a service quality experienced by a user of the client device when the user views the content reproduced by the client device.

36. A relay device adapted to be communicable with a server device and with a client device and also adapted to transfer media data, formed by encoding content, from the server device to the client device, the relay device comprising:
a transmission rate acquisition unit that acquires, as a transmission rate, a transfer rate which is a data quantity of the media data transferred per unit time from the server device to the client device, and
a transmission rate transmission unit that transmits the acquired transmission rate to the server device.

37. A relay method applied to a relay device adapted to be communicable with a server device and with a client device, the method comprising:
transferring media data, formed by encoding content, from the server device to the client device;
acquiring, as a transmission rate, a transfer rate which is a data quantity of the media data transferred per unit time from the server device to the client device; and
transmitting the acquired transmission rate to the server device.

38. A computer-readable medium storing a program comprising instructions for causing a relay device to realize, the relay device being adapted to be communicable with a server device and with a client device and also adapted to transfer media data, formed by encoding content, from the server device to the client device:
a transmission rate acquisition unit that acquires, as a transmission rate, a transfer rate which is a data quantity of the media data transferred per unit time from the server device to the client device, and
a transmission rate transmission unit that transmits the acquired transmission rate to the server device.

39. A distribution system comprising a server device and a client device which are adapted to be communicable with each other, wherein
the server device is adapted to be able to transmit, to the client device, media data which is formed by encoding content at an arbitrary media rate among a plurality of different media rates,
the client device is adapted to, while receiving the media data transmitted by the server device, store received data of the media data in a storage device and reproduce the content based on the stored data, and
the distribution system further comprises:
rate output means for outputting a combination of a transmission rate and a media rate based on an objective function, the objective function being a function in which a transmission rate representing a data quantity of the media data transmitted by the server device per unit time and the media rate respectively serve as variables, and also a function in which a Quality of Experience value is determined so as to correspond to the variables, the Quality of Experience value being a value representing Quality of Experience which is a service quality experienced by a user of the client device when the user views the content reproduced by the client device, and
media data transmission means for transmitting, by the server device, the media data encoded at the output media rate, to the client device at the output transmission rate.

40. A server device adapted to be communicable with a client device,
the server device being adapted to be able to transmit, to the client device, media data which is formed by encoding content at an arbitrary media rate among a plurality of different media rates, the server device comprising:
rate output means for outputting a combination of a transmission rate and a media rate based on an objective function, the objective function being a function in which a transmission rate representing a data quantity of the media data transmitted by the server device per unit time and the media rate respectively serve as variables, and also a function in which a Quality of Experience value is determined so as to correspond to the variables, the Quality of Experience value being a value representing Quality of Experience which is a service quality experienced by a user of the client device when the user views the content reproduced by the client device, and
media data transmission means for transmitting the media data encoded at the output media rate, to the client device at the output transmission rate.

41. A client device adapted to be communicable with a server device which is adapted to be able to transmit, to the client device, media data which is formed by encoding content at an arbitrary media rate among a plurality of different media rates,
the client device being adapted to, while receiving the media data transmitted by the server device, store received data of the media data in a storage device and reproduce the content based on the stored data,
the client device comprising:
rate output means for outputting a combination of a transmission rate and a media rate based on an objective function, the objective function being a function in which a transmission rate representing a data quantity of the media data transmitted by the server device per unit time and the media rate respectively serve as variables, and also a function in which a Quality of Experience value is determined so as to correspond to the variables, the Quality of Experience value being a value representing Quality of Experience which is a service quality experienced by a user of the client device when the user views the content reproduced by the client device, and
request transmission means for transmitting, to the server device, a transmission request which is a request to transmit the media data encoded at the output media rate, at the output transmission rate.

42. A relay device adapted to be communicable with a server device and with a client device and also adapted to transfer media data, formed by encoding content, from the server device to the client device, the relay device comprising:
transmission rate acquisition means for acquiring, as a transmission rate, a transfer rate which is a data quantity of the media data transferred per unit time from the server device to the client device, and
transmission rate transmission means for transmitting the acquired transmission rate to the server device.
